(19) United States
(12) Patent Application Publication
(10) Pub. No.: US 2010/0275183 A1
(43) Pub. Date: Oct. 28, 2010

(54) SOURCE CODE AUDITOR WITH A CUSTOMIZED RULES BUILDER

(76) Inventors: Vinod R. Panicker, Kochi (IN); Pradeep Kumar Pocha, Bellary (IN); Gang Qiang Xu, ZheJiang (CN); Jia Rui, Xiangfan (CN); Karthick K. R., Chennai (IN)

Correspondence Address: GLOBAL IP SERVICES, PLLC, 10 CRESTWOOD LANE, NASHUA, NH, 03062, US

(21) Appl. No.: 12/430,895

(22) Filed: Apr. 28, 2009

(51) Int. Cl. G06F 9/44

(52) U.S. Cl. 717/113

(57) ABSTRACT

A method and apparatus for auditing source code are disclosed. In one embodiment, a method includes generating on a display of a computing device a flowchart of a customized rule for auditing source code of a programming language using a rules builder of the computing device in response to a node of the programming language and a command associated with the customized rule applied to the flowchart. The method also includes converting the customized rule into a specified data format using the rules builder in response to an export command for the customized rule. The method further includes analyzing candidate source code of the programming language using a rules engine of the computing device based on the customized rule in response to an audit command for the candidate source code.

### FIELD OF TECHNOLOGY

Embodiments of the present invention relate to the field of computer software. More particularly, embodiments of the present invention relate to a software designing tool.

### BACKGROUND

A coding standard is a set of rules or guidelines used when writing source code for a computer program. A coding standard according to a particular programming style may help programmers to read and understand source code conforming to the programming style, and help to avoid introducing errors.

There are many applications which come with a standard set of rules for auditing source code for a particular programming language. Although the applications may be helpful in auditing commonly known violations in the source code, they may not cater to individual needs. Furthermore, some of the applications may not allow adding additional rules to the standard set of rules. Even for those which allow the addition, the additional rules may have to be hard coded as a part of those applications or as a plug-in to those applications.

### SUMMARY

A method and apparatus for auditing source code are disclosed. In one aspect, a method for auditing source code includes generating on a display of a computing device a flowchart of a customized rule for auditing source code of a programming language using a rules builder of the computing device in response to at least one node of the programming language and at least one command associated with the customized rule applied to the flowchart, wherein the rules builder includes a graphics editor configured to generate the flowchart. The method also includes converting the customized rule into a specified data format in the computing device in response to an export command for the customized rule using the rules builder. The method further includes analyzing candidate source code of the programming language using a rules engine of the computing device based on the customized rule in response to an audit command for the candidate source code.

In another aspect, an apparatus for auditing source code includes a processor and a memory for temporarily storing a set of instructions, when executed by the processor, causes the processor to perform the method described above.

The methods and apparatuses disclosed herein may be implemented in any means for achieving various aspects, and other features will be apparent from the accompanying drawings and from the detailed description that follow.

### BRIEF DESCRIPTION OF THE DRAWINGS

Various preferred embodiments are described herein with reference to the drawings, wherein:

FIG. 1 illustrates an exemplary computing device operable for practicing various embodiments of the present invention;

FIG. 2A illustrates an exemplary network environment operable for practicing various embodiments of the present invention;

FIG. 2B illustrates an exemplary handheld device working in an exemplary network environment, according to one embodiment;

FIG. 3 illustrates an exemplary source code;

FIG. 4A through FIG. 4C illustrate an exemplary process for generating a customized rule using a rules builder of FIG. 1, according to one embodiment;

FIG. 5 illustrates an exemplary process for importing the customized rule of FIG. 4C, according to one embodiment;

FIG. 6 illustrates an exemplary process for analyzing candidate source code using the customized rule, according to one embodiment; and

FIG. 7 illustrates a process flow chart of an exemplary method for generating a customized rule for auditing source code, according to one embodiment.

The drawings described herein are for illustration purposes only and are not intended to limit the scope of the present invention in any way.

### DETAILED DESCRIPTION

A method and apparatus for auditing source code are disclosed. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

The terms “analyzing” and “auditing” are used interchangeably throughout the document. Also, in the document, the term “candidate source code” refers to any source code being audited using a customized rule.

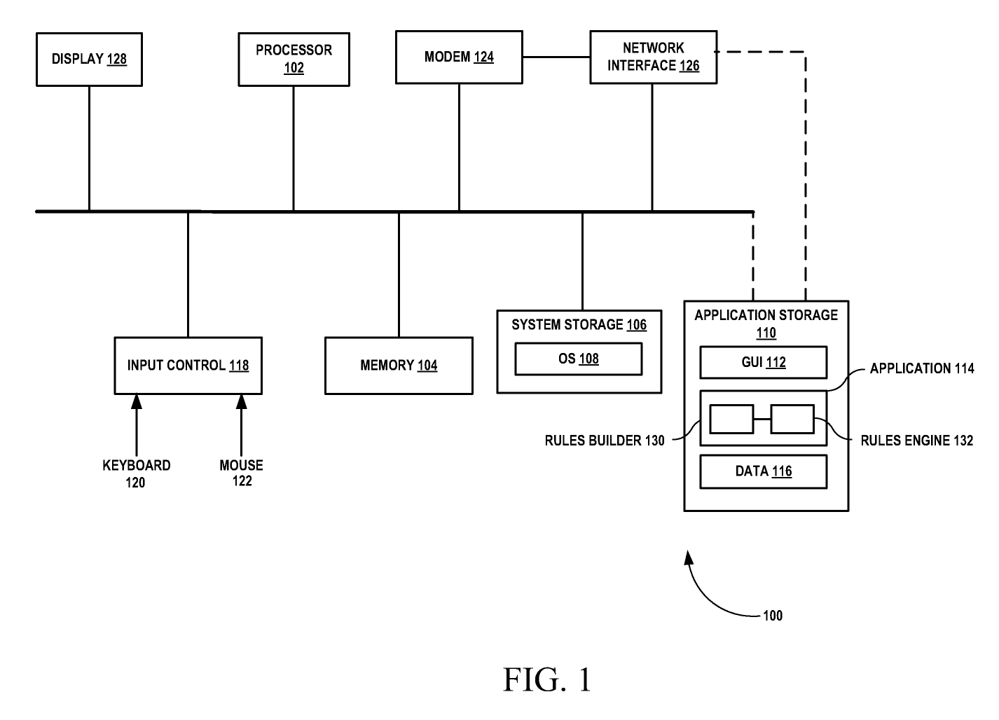

FIG. 1 illustrates an exemplary computing device 100 operable for practicing various embodiments of the present invention. One of ordinary skill in the art will appreciate that the computing device 100 is intended to be illustrative and not limiting of the present invention. The computing device 100 may take many forms, including but not limited to a workstation, server, network computer, quantum computer, optical computer, bio-computer, Internet appliance, mobile device, pager, tablet computer, and the like.

The computing device 100 may be an electronic device and includes a processor 102, a memory 104, a system storage 106 storing an operating system 108, an application storage 110 storing a graphical user interface (GUI) 112, an application 114, data 116, an input control 118 for a keyboard 120 and a mouse 122, a modem 124, a network interface 126, a display 128, etc. The processor 102 controls each component of the computing device 100 to audit source code based on one or more customized rules. The memory 104 temporarily stores instructions and data and provides the stored instructions and data to the processor 102 so that the processor 102 operates the computing device 100 to generate the customized rule(s) (e.g., using a rules builder 130 of the application 114) and auditing source code based on the customized rule(s) (e.g., using a rules engine 132 of the application 114).

The system storage 106 includes code for the OS 108 of the computing device 100. The application storage 110 includes code for the application 114 running on the OS 108 which generates the customized rule(s) and the audit source code based on the customized rule(s) as well as the data 116 associated with the customized rule(s). In one example implementation, the system storage 106 and the application storage 110 may be implemented using a single storage. In another example implementation, the GUI 112, the application 114, and the data 116 may be stored in different storage devices.

The input control 118 may interface with the keyboard 120, the mouse 122, and other input devices. The computing device 100 may receive, through the input control 118, input data necessary for creating the customized rule(s). The computing device 100 may display user interfaces in the display 128 for users to create, edit and reuse the customized rule(s). Moreover, the application storage 110 may interface with the computing device 100 directly with the bus of the computing device 100 or via the network interface 126.

In one embodiment, the computing device 100 or an apparatus for auditing source code includes the processor 102 and the memory 104 for temporarily storing a set of instructions. The set of instructions, when executed by the processor 102, causes the processor 102 to perform a method comprising generating on the display 128 of the computing device 100 a flowchart of a customized rule for auditing source code of a programming language using the rules builder 130 of the computing device 100 in response to at least one node of the programming language and at least one command associated with the customized rule applied to the flowchart, wherein the rules builder 130 includes a graphics editor configured to generate the flowchart. The method also includes converting the customized rule into a specified data format in the computing device 100 in response to an export command for the customized rule using the rules builder 130. The method further includes analyzing candidate source code of the programming language using the rules engine 132 of the computing device 100 based on the customized rule in response to an audit command for the candidate source code.

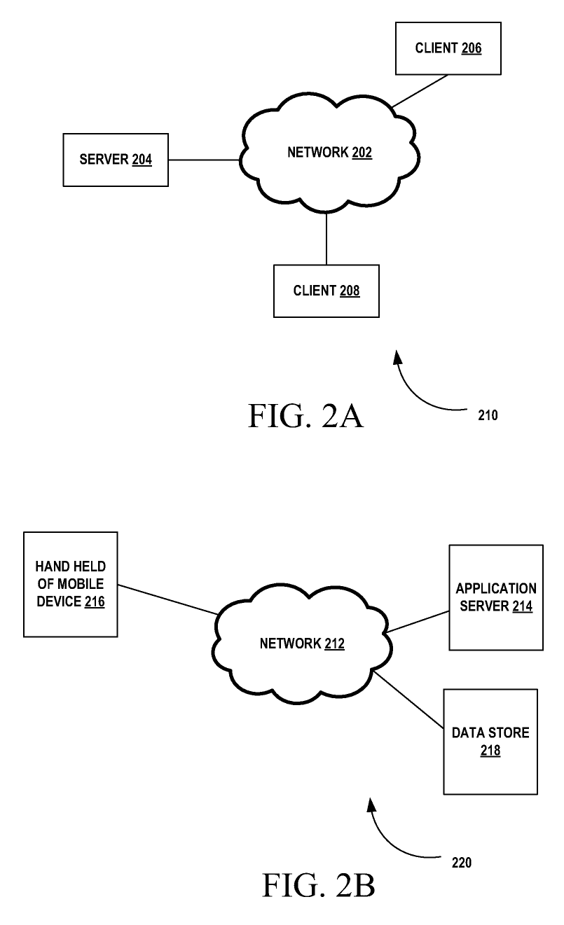

FIG. 2A illustrates an exemplary network environment 210 or system operable for practicing various embodiments of the present invention. The network environment 210 may include a server 204 coupled to clients 206 and 208 via a network 202 (e.g., a communication network). The server 204 and the clients 206 and 208 can be implemented using the computing device 100 depicted in FIG. 1.

The network interface 126 and the modem 124 of the computing device 100 enable the server 204 to communicate with the clients 206 and 208 through the network 202. The network 202 may include Internet, intranet, LAN (Local Area Network), WAN (Wide Area Network), MAN (Metropolitan Area Network), etc. The communication facilities can support the distributed implementations of the present invention.

In the network environment 210 the server 204 may provide the clients 206 and 208 with software components or products under a particular condition, such as a license agreement. The software components or products may include those for generating and reusing the customized rule(s) as illustrated in FIG. 1. The server 204 may send the clients 206 and 208 the software components or products under a specific license agreement.

FIG. 2B illustrates an exemplary handheld device 216 working in an exemplary network environment 220, according to one embodiment. The network environment 220 may include an application server 214 coupled to the handheld device 216 via a network 212. The application server 214 and the handheld device 216 can be implemented using the computing device 100 depicted in FIG. 1.

The network interface 126 and the modem 124 of the computing device 100 enable the application server 214 to communicate with the handheld device 216 through the network 212. In one embodiment of the network environment 220, the handheld device 216 may be configured to run the application 114 independently if the handheld device 216 is equipped with the application storage 110 which includes the GUI 112, the application 114, and the data 116. In another embodiment of the network environment 220, the handheld device 216 may be configured to run the application 114 using the data 116 residing in a data store 218 via the network 212 if the handheld device 216 is equipped with an application storage which includes the GUI 112 and the application 114. In yet another embodiment of the network environment 220, the handheld device 216 may be configured to run the application 114 serviced by the application server 214 using the data 116 stored in the data store 218 via the network 212 if the handheld device 216 is equipped with the GUI 112 only.

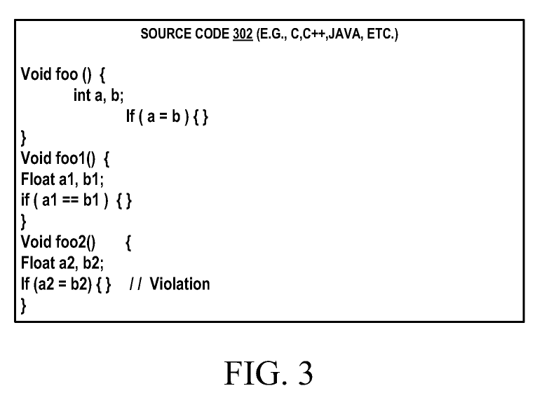

FIG. 3 illustrates an exemplary source code 302. It is appreciated that, the source code is based on programming languages such as C, C++, JAVA, etc. In one embodiment, the source code 302 is analyzed using a customized rule for checking custom coding standards. The generation of the customized rule for auditing the source code 302 is described in the description that follows.

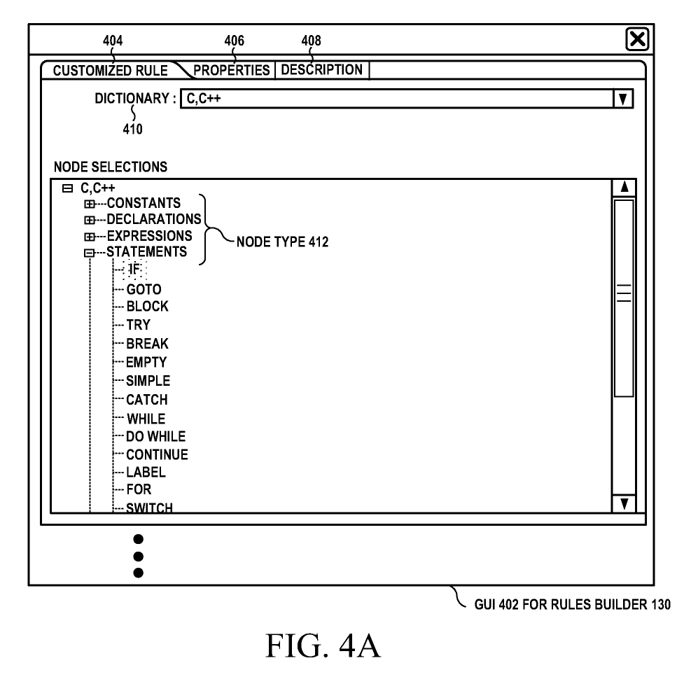

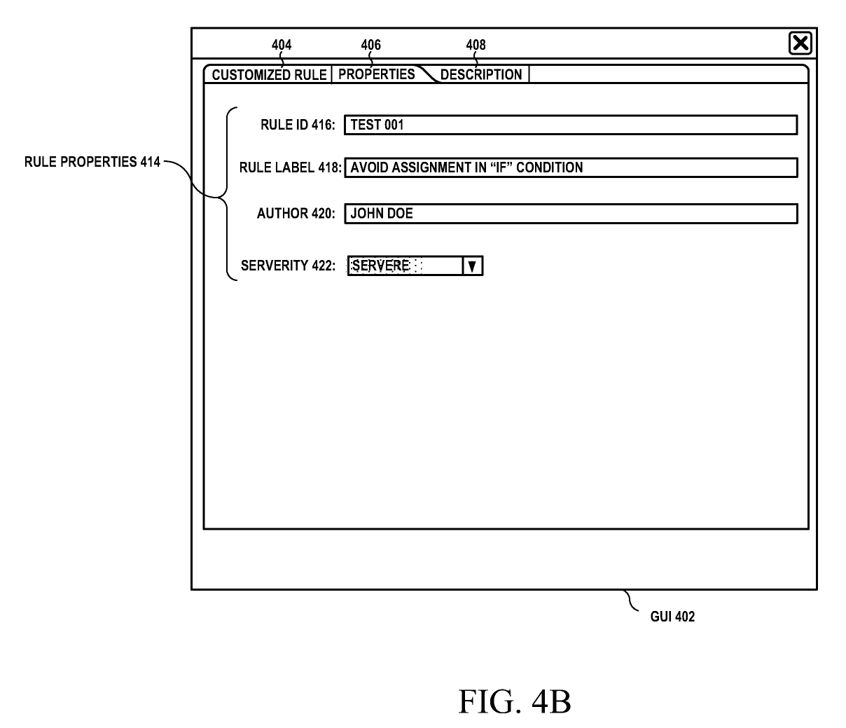

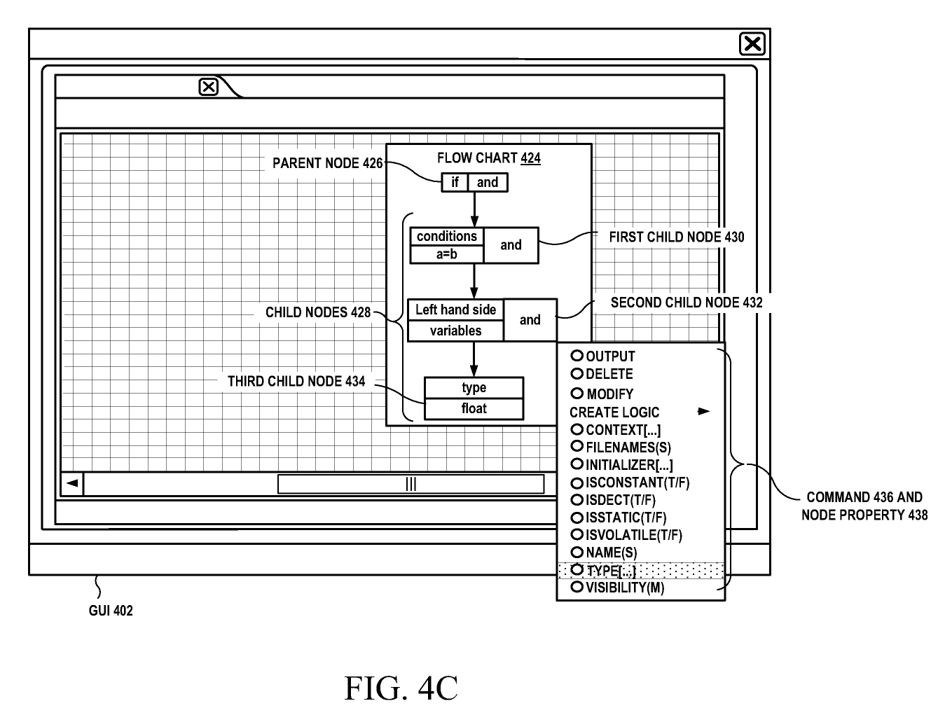

FIG. 4A through FIG. 4C illustrate an exemplary process for generating a customized rule using the rules builder 130 of FIG. 1, according to one embodiment. Particularly, FIG. 4A through FIG. 4C illustrate a graphical user interface (GUI) 402 for the rules builder 130 used for generating the customized rule for auditing source code (e.g., the source code 302 of FIG. 3). The GUI 402 displays a customized rule tab 404, a properties tab 406 and a description tab 408.

As shown in FIG. 4A, the GUI 402 allows selection of at least one node associated with a node type 412 of a programming language (e.g., C, C++, Java, etc.) using the customized rule tab 404 for generating the customized rule. In one embodiment, the node type 412 of the programming language is displayed under the customized rule tab 404 when the node type 412 of the programming language is searched using a dictionary field 410. Further, each node type 412 displayed in the GUI 402 may include one or more nodes used for generating the customized rule. In one exemplary implementation, the one or more nodes are captured using a metadata repository (MDR).

In the example embodiment illustrated in FIG. 4A, the GUI 402 displays the node type 412 associated with C and C++ programming languages when the node type 412 for the C and C++ programming languages is searched using the dictionary field 410. For example, the node type 412 for the C and C++ programming languages may include a constant, a declaration, an expression, a statement, a name space, a type, and a general in type.

It is appreciated that, the constant node type may include nodes such as integer, real, string, bool enum, and template parameter. The declaration node type may include nodes such as friend, functions (e.g., global function, member function, etc.), parameter, and variables (e.g., global variable, local variable, member variable, etc.). The expression node type may include nodes such as assignment (e.g., a=b, â=b, a%=b, etc.), bitwise (e.g., a&b, ˜a, âb, etc.), comparison (e.g., a>b, a==b, etc.), logical (e.g., !a, a&&b, etc.), numerical (e.g., +a, −a, %a, a*b, etc.), and miscellaneous (e.g., a(b), a,b, a.b, etc.).

The statement node type may include nodes such as if, goto, block, try, break, empty, simple, catch, while, do while, continue, label, for, and switch. The name space node type may include nodes such as name space and using. The type node type may include nodes such as complex (e.g., template parameter, array, class, enum, function, etc.) and primitive (e.g., bool char, double, float, int, etc.). The general node type may include nodes such as base type, argument, file, and template argument

As illustrated in FIG. 4A, the “if” node is selected as a first one of the node for generating the customized rule for auditing the source code 302. Further, FIG. 4B illustrates the GUI 402 displaying rule properties 414 applied to the first one of the node (e.g., the “if” node) under the properties tab 406. As illustrated, the GUI 402 displays various fields, such as a rule identifier (ID) field 416, a rule label field 418, an author field 420 and a severity field 422, which facilitate a user to configure the rule properties 414 applied to the first one of the node.

The rule ID field 416 allows the user to assign a unique rule ID for the customized rule. The rule label field 418 allows the user to assign a name for the customized rule. The author field 420 allows the user to provide an author name or a group name associated with generating of the customized rule. The severity field 422 facilitates the user to choose a severity category (e.g., recommendation, warning, severe, etc.) based on which the customized rule is classified.

In the example embodiment illustrated in FIG. 4B, the rules properties 414 applied to the “if” node are displayed. The rule ID field 416 displays the unique rule ID assigned for the customized rule as “Test 001”. Further, the rule label field 418 displays the name assigned to the customized rule as “Avoid assignment in “if” condition”. The author field 420 displays the author name as “John Doe” and the severity field 422 displays the severity category selected from a drop down menu as “Severe”. Also, the description tab 408 in the GUI 402 facilitates the user to provide description associated with the customized rule (e.g., indicating a nature of error when the source code violates the customized rule).

FIG. 4C illustrates a process for generating a flowchart 424 of the customized rule using a graphics editor. It is appreciated that, the graphics editor is an exemplary implementation of the GUI 402. It can be seen in FIG. 4C that, the flowchart 424, displayed in the GUI 402, includes a parent node 426 (e.g., expression, variable, constant, function, statement, etc.), and child nodes 428 which are dependent of the parent node 426. The parent node 426 is generated on the flowchart 424 in response to a selection of the first one of the node (e.g., the “if” node) and the respective rule properties 414 applied to the selected first one of the node. Further, each of the child nodes 428 is generated by applying a command 436 and a node property 438 to each of the child nodes 428.

For example, the command may be a modify, an output, a delete, a delete child, a create logic and a change logic in type. For example, the modify command allows the user to modify one or more nodes displayed in the flowchart 424. The output command allows the user to configure an error message to be displayed if the customized rule is violated. The delete command enables the user to delete selected one or more nodes in the flowchart 424. The delete child command enables the user to delete selected child node(s) 428 in the flowchart 424.

The create logic command enables the user to create logic in the flowchart 424 while generating the child nodes 428. The change logic command enables the user to change the type of logic operator used in a particular node in the flowchart 424. For example, the user can change an AND operator to an XOR operator using the change logic command. In one exemplary implementation, the command 436 is captured using the MDR. The node property 438 may be arguments, body, catch, condition, constructor initialization list, context, default, dimension, else, entity, FalseChoice, filename, HasElse, HasForwardDecl, HasMultipleParents, HasVoid, etc.

In the example embodiment illustrated in FIG. 4C, the flowchart 424 of the customized rule includes a single parent node 426 and three child nodes 428 (e.g., a first child node 430, a second child node 432, and a third child node 434) which are dependent on the parent node 426. The parent node 426 is generated in response to the selection of the “if” node and the respective rule properties 414 applied to the “if” node as explained above in the description of FIGS. 4A and 4B.

Further, the first child node 430 is generated for filtering all assignment statements inside condition of the “if” statement. The first child node 430 is generated by applying the command “create logic” and the node property “condition”, and in response to selection of a node “a=b” from the node type “expression” based on the node property “condition”. Furthermore, the second child node 432 is generated for filtering a variable of a left hand side part of the assignment statement. The second child node 432 is generated by applying the command “create logic” and the node property “left hand side”, and in response to selection of a node “variable” from the node type “declaration” based on the node property “left hand side”.

Moreover, as illustrated in FIG. 4C, the third child node 434 is generated for filtering the left hand side variable of type float. The third child node 434 is generated by applying the command “create logic” and the node property “type”, and in response to selection of a node “float” from the node type “type” based on the node property “type”. In this manner, the flowchart 424 of the customized rule illustrated in FIG. 4C is generated. Thus, the customized rule can filter the “if” statement with the assignment inside the condition (“a=b”), whose left hand side variable which is of type float. In one exemplary implementation, the customized rule is converted into a specified data format in response to an export command for the customized rule. For example, the GUI 402 may provide an export command button for converting the customized rule in the specified data format.

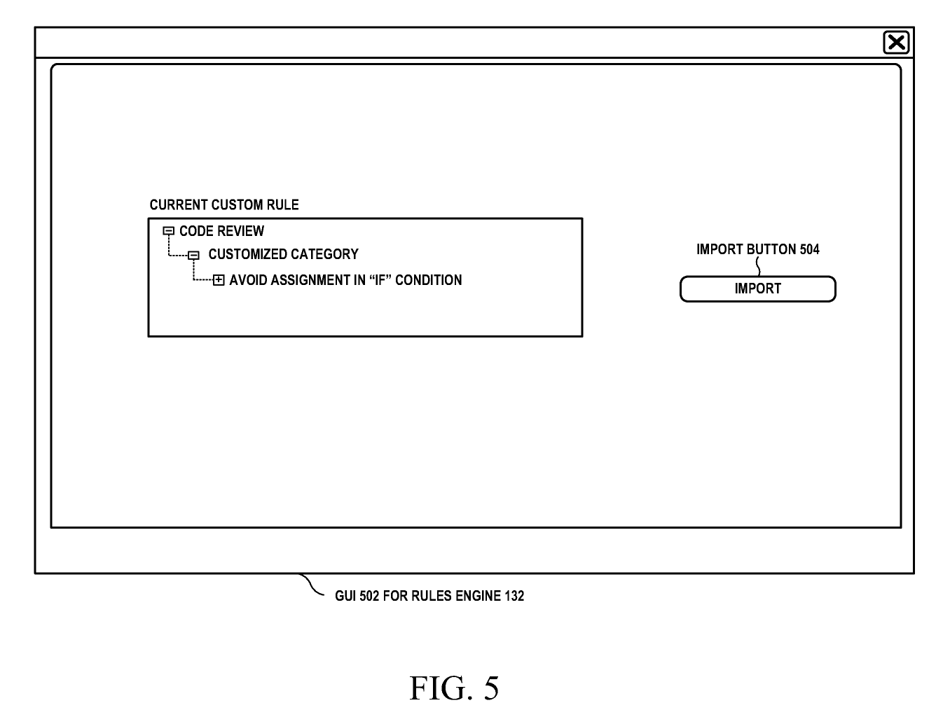

FIG. 5 illustrates an exemplary process for importing the customized rule of FIG. 4C, according to one embodiment. Particularly, FIG. 5 illustrates a GUI 502 for the rules engine 132 which enables importing a customized rule (e.g., “avoid assignment in “if” condition”). As illustrated, the GUI 502 includes an import button 504 which enables the user to import the customized rule in a specified data format from a designated location where it was previously stored.

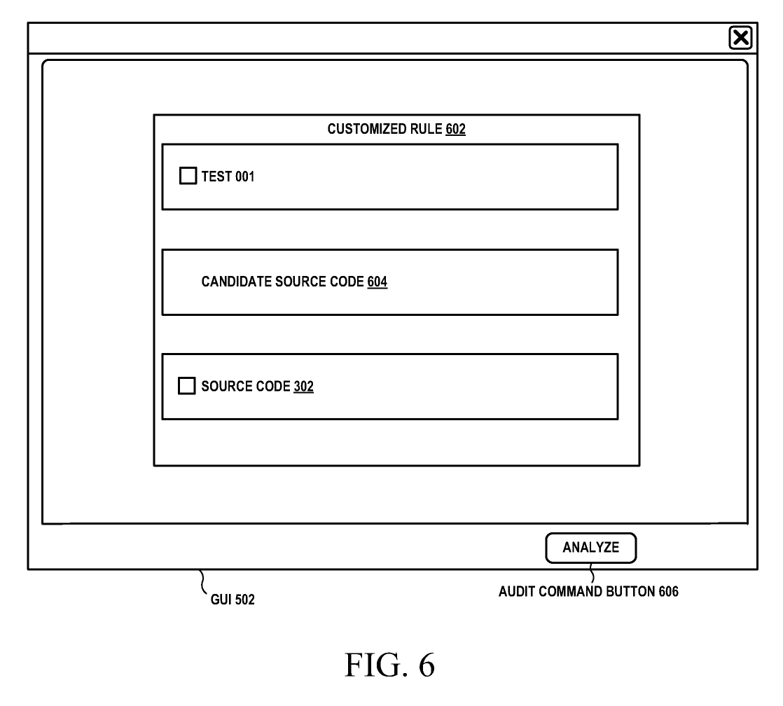

FIG. 6 illustrates an exemplary process for analyzing candidate source code 604 using a customized rule 602, according to one embodiment. In one embodiment, the candidate source code 604 of a programming language is analyzed based on the customized rule 604, imported using the GUI 502 as illustrated in FIG. 5. As shown in FIG. 6, the GUI 502 includes an audit command button 606.

In one embodiment, the GUI 502 enables the user to analyze the candidate source code 604 based on the customized rule 602 in response to the selection of the audit command button 606. In the example embodiment illustrated in FIG. 6, the candidate source code 604 to be analyzed is “source code 302” (as shown in FIG. 3) and the imported customized rule 602 is “Test 001”. As illustrated, the source code 302 is analyzed using “Test 001” upon clicking the audit command button 606 in the GUI 502.

Further, based on the analysis of the candidate source code 604, the GUI 502 outputs a result of analysis of the candidate source code 604 with respect to the customized rule 602. In one embodiment, the GUI 502 displays a violation by the candidate source code 604 if the customized rule 602 is violated by the candidate source code 604. For example, the GUI 502 displays the violation as an error message (e.g., configured by the user using “output” command while generating the flowchart 424).

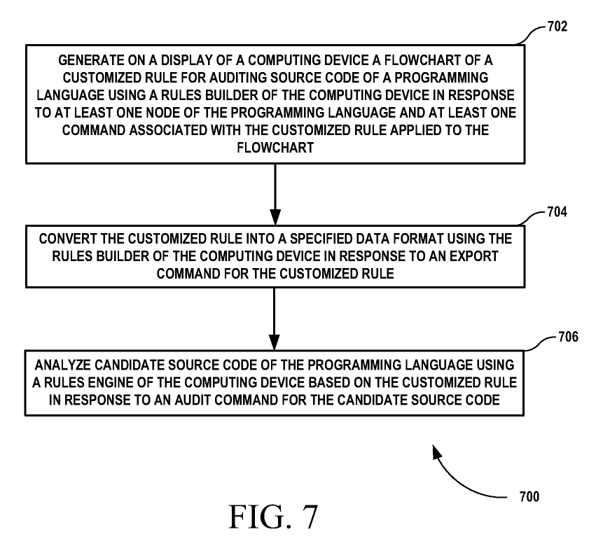

FIG. 7 illustrates a process flow chart of an exemplary method 700 for generating a customized rule for auditing source code, according to one embodiment. In step 702, a flowchart of a customized rule for auditing source code of a programming language is generated on a display of a computing device using a rules builder (e.g., a graphics editor) of the computing device. The flowchart of the customized rule is generated in response to at least node of the programming language and at least one command associated with the customized rule applied to the flowchart. For example, the at least one node and the at least one command are captured using a MDR.

In one embodiment, the flowchart of the customized rule is generated by generating a parent node on the flowchart in response to a selection of a first one of the node and respective properties applied to the first one of the node. Further, the flowchart of the customized rule is generated by generating a child node dependant on the parent node, and applying a command and a node property to each of the child node.

In step 704, the customized rule is converted into a specified data format using the rules builder in response to an export command for the customized rule. Further, in step 706, candidate source code of the programming language is analyzed using a rules engine of the computing device based on the customized rule in response to an audit command for the candidate source code. Moreover, in one example embodiment, a computer readable medium, for generating a customized rule for auditing source code, has instructions that, when executed by a computer, cause the computer to perform the method illustrated in FIG. 7.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present disclosure is not intended to be limited to the embodiments shown herein but is to be accorded the widest scope consistent with the principles and features disclosed herein.

What is claimed is:

1. A method, implemented in a computing device, for auditing source code, comprising:
generating on a display of the computing device a flowchart of a customized rule for auditing source code of a programming language using a rules builder of the computing device in response to at least one node of the programming language and at least one command associated with the customized rule applied to the flowchart, wherein the rules builder comprises a graphics editor configured to generate the flowchart;
converting the customized rule into a specified data format using the rules builder in response to an export command for the customized rule; and
analyzing candidate source code of the programming language using a rules engine of the computing device based on the customized rule in response to an audit command for the candidate source code.

2. The method of claim 1, wherein the programming language comprises a C, C++, and JAVA.

3. The method of claim 1, wherein the customized rule further comprises at least one output and at least one rule property.

4. The method of claim 1, wherein the at least one node and the at least one command are captured using a metadata repository (MDR).

5. The method of claim 3, wherein the node comprises a constant, a declaration, an expression, a statement, a name space, a type, and a general in type.

6. The method of claim 3, wherein the command comprises a modify, an output, a delete, a delete child, a create logic, and a change logic in type.

7. The method of claim 1, wherein the generating the flowchart of the customized rule comprises generating a parent node on the flowchart in response to a selection of a first one of the at least one node and respective rule properties applied to the first one of the at least one node.

8. The method of claim 7, wherein the rule properties comprise a rule identifier (ID), a rule label, an author, and a severity associated with the customized rule.

9. The method of claim 7, wherein the generating the flowchart of the customized rule further comprises:
generating at least one child node dependant on the parent node; and
applying at least one of a command and a node property to each of the at least one child node.

10. The method of claim 1, wherein the analyzing the candidate source code comprises importing the customized rule using the rules engine.

11. The method of claim 3, wherein the analyzing the candidate source code comprises displaying at least one violation by the candidate source code with respect to the customized rule.

12. The method of claim 11, wherein the output is used for the displaying the at least one violation.

13. The method of claim 1, wherein the specified data format comprises an extensible markup language (XML) file format.

14. An apparatus for auditing source code, comprising:
a processor; and
a memory for temporarily storing a set of instructions, when executed by the processor, causes the processor to perform a method comprising:
generating on a display of a computing device a flowchart of a customized rule for auditing source code of a programming language using a rules builder of the computing device in response to at least one node of the programming language and at least one command associated with the customized rule applied to the flowchart, wherein the rules builder comprises a graphics editor configured to generate the flowchart;
converting the customized rule into a specified data format using the rules builder in response to an export command for the customized rule; and
analyzing candidate source code of the programming language using a rules engine of the computing device based on the customized rule in response to an audit command for the candidate source code.

15. The apparatus of claim 14, further comprising an application storage for storing an application having the set of instructions.

16. A computer readable medium having instructions that, when executed by a computer, cause the computer to perform for auditing source code comprising:
generating on a display of the computer a flowchart of a customized rule for auditing source code of a programming language using a rules builder of the computer in response to at least one node of the programming language and at least one command associated with the customized rule applied to the flowchart, wherein the rules builder comprises a graphics editor configured to generate the flowchart;
converting the customized rule into a specified data format using the rules builder in response to an export command for the customized rule; and
analyzing candidate source code of the programming language using a rules engine of the computer based on the customized rule in response to an audit command for the candidate source code.

17. The computer readable medium of claim 16, wherein the generating on the display of the computer the flowchart of the customized rule comprises generating a parent node on the flowchart in response to a selection of a first one of the at least one node and respective rule properties applied to the first one of the at least one node.

18. The computer readable medium of claim 17, wherein the generating on the display of the computer the flowchart of the customized rule further comprises:
generating at least one child node dependant on the parent node; and
applying at least one of a command and a node property to each of the at least one child node.

19. The computer readable medium of claim 16, wherein the analyzing the candidate source code comprises importing the customized rule using the rules engine.

20. The computer readable medium of claim 16, wherein the at least one node and the at least one command are captured using a metadata repository (MDR).

21. A computer network system comprising a server and a plurality of clients, when the server requested by the clients for a service, causes the clients to perform a method of effectively using software tools for a software development project comprising:
generating on a display of a computer associated with each client a flowchart of a customized rule for auditing source code of a programming language using a rules builder of the server in response to at least one node of the programming language and at least one command associated with the customized rule applied to the flowchart, wherein the rules builder comprises a graphics editor configured to generate the flowchart;
converting the customized rule into a specified data format using the rules builder in response to an export command for the customized rule; and
analyzing candidate source code of the programming language using a rules engine of the server based on the customized rule in response to an audit command for the candidate source code.
